(19) United States
(12) Patent Application Publication
(10) Pub. No.: US 2021/0215175 A1
(43) Pub. Date: Jul. 15, 2021

(54) Installation for Controlling a Hydraulic Installation with a Plurality of Receivers Operating in Parallel

(71) Applicant: Robert Bosch GmbH, Stuttgart (DE)

(72) Inventors: Denis Nguon, Lyon (FR); Gilles Florean, Lyon (FR)

(21) Appl. No.: 17/143,830

(22) Filed: Jan. 7, 2021

(30) Foreign Application Priority Data
Jan. 9, 2020 (FR) 2000167

(51) Int. Cl. F15B 15/18; F04B 49/06

(52) U.S. Cl. CPC F15B 15/18; F15B 2211/465; F15B 2211/20538; F04B 49/065

(57) ABSTRACT

A control system for controlling a hydraulic installation with a plurality of receivers operating in parallel includes control units which regulate control positions of each of the receivers supplied by a pump, the pressure and flow rate of which are regulated by a regulator with or without flow rate sharing. The distributor associated with each receiver is switched between modes by a switch associated with each receiver. A counter supplies a control signal to the switches in order to switch them to flow rate sharing mode, if at least two receivers must be activated. Each control unit generates a pressure value and a flow rate value in order, in flow rate sharing mode, to generate a flow rate regulation signal corresponding to the sum of all the flow rates, and a pressure signal corresponding to the highest pressure out of all the pressures.

This application claims priority under 35 U.S.C. § 119 to application no. 2000167, filed on Jan. 9, 2020 in France, the disclosure of which is incorporated herein by reference in its entirety.

The present disclosure relates to an installation for controlling a hydraulic installation with a plurality of receivers operating in parallel, comprising:
receivers which are supplied by a pump, the pressure and flow rate of which are regulated by a flow rate sharing regulator; and
a distributor which is associated with each receiver, in order to supply the receiver in a controlled manner downstream from the pump, according to the control position of the control unit.

### BACKGROUND

Hydraulic installations are known which equip for example construction machinery such as excavators with a plurality of hydraulic functions, which installations are supplied by a pump, and permit simultaneous operation of a plurality of pieces of equipment. They are composed of a main hydraulic circuit with a controlled pump, which is driven by a motor, and supplies the shunt circuits connected to each actuator (receiver) by means of a distributor with a slider actuated by control signals, on the basis of the movement or position of the control lever.

The displacement or position of the control unit by the operator is detected and used thus to generate an electrical or hydraulic control signal in order to actuate the slider of the distributor associated with this equipment or this function.

At the output from the pump, and downstream from the distributor, two pressure sensors supply two pressure signals to a compensator which controls the operation of the pump, and thus takes into account the implementation of the different receivers.

Schematically, each control lever sends a control pressure signal corresponding to its angle of actuation. This control pressure acts directly on the slider of the distributor associated with the actuator. The pump is controlled by a flow rate regulator.

If the flow rate is sufficient at a given pressure, the flow rate is distributed between the actuators, which can then operate at the required speed.

However, if the flow rate is insufficient, the distribution does not take place, and there is loss of control of the operating speed of the actuators, since the flow will go by precedence to the least loaded actuator.

This disadvantage is avoided by means of compensators which are incorporated in the supply line of each actuator. These compensators which detect the pressure in the supply line of each actuator are connected directly to a selector which sends the highest pressure signal to the regulator of the pump. The pressure difference which is generated by the pump subsides, and the compensators step in, more or less shutting down the supply to the actuators.

The speed drops, but the speed ratio between the different actuators is maintained.

To conclude, this installation requires complex hydraulic devices, in particular hydro-mechanical compensators in order to balance and harmonize the sharing of the flow rate of the pump which supplies the actuators and their equipment.

### SUMMARY

The objective of the present disclosure is to provide an installation for controlling a hydraulic installation comprising a plurality of receivers which can operate in parallel, and have different and variable operating characteristics, in order to simplify the control means thereof, and make them more reliable and more accurate.

For this purpose, the subject of the disclosure is a system for controlling a hydraulic installation with a plurality of receivers (Rᵢ) operating in parallel, comprising:

control units Jᵢ in order to regulate a control position (αⱼ) of each of the receivers Rᵢ supplied by a pump (1), the pressure (P) and flow rate (Q) of which are regulated by regulator (6), with or without flow rate sharing,
a distributor (Dᵢ) associated with each receiver (Rᵢ) in order to supply to the receiver, according to the control position (αⱼ) of the control unit (Jᵢ), which control system is characterized in that:
it comprises an operating mode switch (PTᵢ) which is associated with each receiver Rᵢ and switches the distributor (Dᵢ) in order to supply to the distributor with or without flow rate sharing; and

a flow rate value counter (26) which supplies an operating mode control signal (SX) to the switches PTᵢ (i=1 . . . n), in order to switch them to flow rate sharing mode, if at least two receivers (Rᵢ) must be activated, or to a mode without flow rate sharing, if a single receiver (Rᵢ) is activated;

each control unit (Jᵢ) activated at an instant (t) generates a pressure value (Pᵢ (αⱼ)) and a flow rate value (Qᵢ (αⱼ)) according to its control position (αⱼ), in order, in flow rate sharing mode to:
generate a flow rate regulation signal (SQC) corresponding to the sum of all the flow rates (Qᵢ (αⱼ)), and a pressure signal (SPₘₐₓ) corresponding to the highest pressure (Pₘₐₓ) out of all the pressures (Pᵢ (αⱼ)), in order to control the pump (1); and
regulate each distributor (Dᵢ) at the instant (t) depending on the flow rate required (Qᵢ (αⱼ)) at that instant according to the control position (αⱼ).

This control system thus incorporates all the activated branches of the hydraulic installation. Even the branches which are not activated are integrated automatically, since they supply pressure and flow rate demand signals which are zero, and do not intervene either in the total of the flow rates, or in the selection of the maximal pressure.

The distribution of the flow rate of the pump takes place without jarring in the operation of the different pieces of equipment, whilst permitting the equipment which is the most loaded to operate in good conditions even if its speed is lower than its normal operating speed.

According to a particularly advantageous characteristic, the regulation of each distributor also depends on the pressure required at this instant by the control unit associated with this distributor.

According to an advantageous characteristic, the control unit is combined with a conversion unit containing a table of the pressure and flow rate values associated with each control position of the control unit of the receiver, these values being the pressures and flow rates measured for the receiver taken in isolation for the control positions.

According to another advantageous characteristic in flow rate sharing mode, the flow rate required for the regulation position is combined with a corrector coefficient which depends on the pressure required in order to form the control signal of the distributor regulating the supply of the receiver.

According to another advantageous characteristic, the distributors are electrohydraulic distributors controlled by a basic intensity which depends on the flow rate required by the distributor considered alone without flow rate sharing, with the control intensity of the distributor alone controlling the cross-section of passage between the total closure and opening according to the control position, and, in flow rate sharing mode, the control signal is the intensity multiplied by the correction coefficient.

According to another advantageous characteristic, the pump is controlled by the pressure signal, which is the maximal pressure of the pressures required by the control units and by the cumulative flow rate signal which is the total of the flow rates required.

Thus, all the branches are involved in this control system, since, as already indicated, those which are not operating demand a zero flow rate which does not intervene in the total of the flow rates.

According to another advantageous characteristic, the corrector coefficient CRᵢ of each receiver Rᵢ depends on the common parameters of the hydraulic circuit at the instant (t) (Pₘₐₓ, N, No) and on the pressure required Pᵢ (αⱼ) according to the formula:

$${CR}_{i} = \sqrt{\frac{N}{Pmax * No}} * \sqrt{Poi} \qquad ( 2 )$$

In this formula:

Poᵢ=pressure in the receiver Rᵢ at the minimum speed No;

No=minimum speed of rotation of the motor;

Pₘₐₓ=maximum pressure of all of the operating pressures required by the equipment Eᵢ (Rᵢ) activated at an instant (t);

N=speed of rotation of the motor of the pump at the instant (t).

Finally, in general, the subject of the disclosure is a system for controlling a hydraulic installation with a plurality of receivers operating in parallel with distribution of the flow rate of the pump, comprising:
a pump which is driven by a motor rotating at a speed at the instant, and regulated by a regulator receiving a pressure signal and a flow rate signal;
branches, each comprising their own means connecting a control unit to the hydraulic receiver of the equipment controlled by the unit;
a conversion unit connected to the control unit, in order to receive the control position thereof, and generate the flow rate required and the pressure required;
a mode selector associated with each receiver, and switching the distributor for supply with or without flow rate sharing; and
a counter of flow rate values supplying an operating mode control signal to the selectors (PTᵢ) (i=1 . . . n) in order to switch them to flow rate sharing mode if at least two receivers must be activated, or to the mode without flow rate sharing if a single receiver is activated;
a processing module in order to form the corrector coefficient of the flow rate required, and then the control signal of the distributor in flow rate sharing mode;
an adder receiving the flow rates required in order to add them and form the flow rate control signal which is the total of the flow rates;
a maximum pressure selector receiving the pressures required and maintaining the maximal pressure required;
a sensor for the speed of the motor;
a table containing the pressures and the minimum speed of rotation of the receivers taken separately for the motor of the pump rotating at the minimal speed;
the cumulative flow rate signal and the maximum pressure signal being applied to the regulator of the pump;
the “and” signals being applied to each processing module;
the “and” signals being applied to the processing module;
the processing module (MTᵢ) forms the correction signal CRᵢ according to the formula:

$${CR}_{i} = \sqrt{\frac{N}{Pmax * No}} * \sqrt{Poi} \qquad ( 2 )$$

wherein:

Poᵢ=pressure in the receiver Rᵢ at the minimum speed No;

No=minimum speed of rotation of the motor;

Pₘₐₓ=maximum pressure of all of the operating pressures required by the equipment Eᵢ (Rᵢ) activated at an instant (t);

N=speed of rotation of the motor of the pump at the instant (t).

According to an advantageous characteristic, in flow rate sharing mode, the control signal (SCDᵢ (αᵢ)) of the distributor (Dᵢ) is the intensity (Iᵢ (αᵢ)) of control of the distributor (Dᵢ) considered alone without flow rate sharing according to the control position (αⱼ) of the control unit (Jᵢ) multiplied by the correction coefficient (CRᵢ (αⱼ))

SCDᵢ=CRᵢ·Iᵢ·(αⱼ))

### BRIEF DESCRIPTION OF THE DRAWINGS

The present disclosure will be described hereinafter in greater detail by means of an embodiment of a control installation represented in the appended drawings in which:

FIG. 1 is a general diagram of a control installation combined with a hydraulic installation with a plurality of receivers which can operate in parallel;

FIG. 2 is a simplified diagram of FIG. 1; and

FIG. 3 is a developed part of the diagram in FIG. 2.

### DETAILED DESCRIPTION

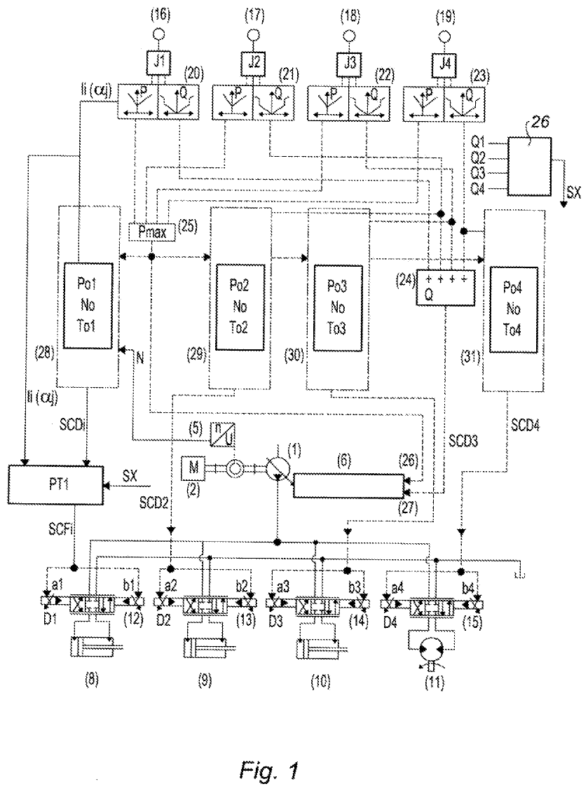

FIG. 1 shows an embodiment of a hydraulic installation 100 for controlling hydraulic actuators (receivers) Rᵢ (i=1 . . . 4) associated with mechanical equipment Eᵢ, with jacks and/or hydraulic motors supplied by a pump 1 controlled by a pressure and flow regulator 6 which fixes the pressure and flow rate operating points of the pump 1 for the hydraulic circuit thus formed by the different pieces of equipment.

The control installation 100 is composed of (4) parallel branches BRᵢ (i=1 . . . 4), each being associated with a receiver Rᵢ. The branches BRᵢ are supplied in parallel by the pump 1 with flow rate sharing between the branches which are active at each instant (t), and without flow rate sharing if a single branch BRᵢ is activated.

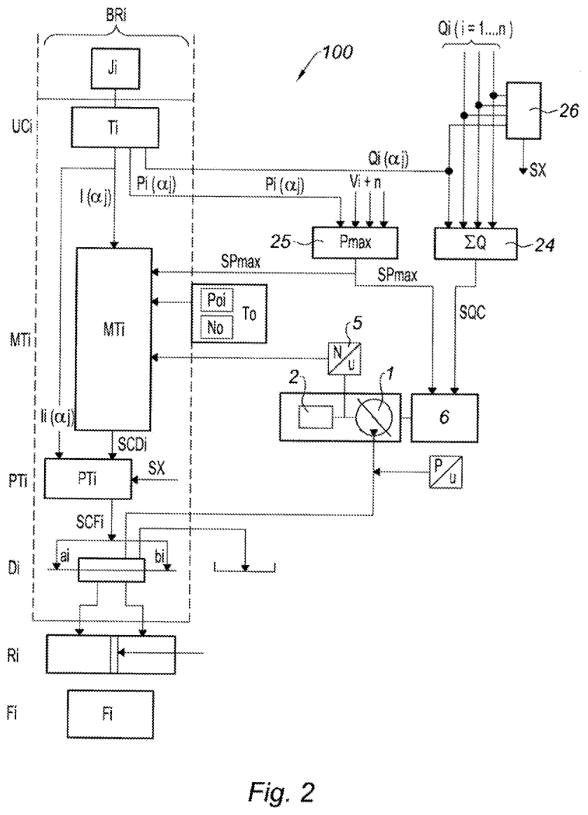

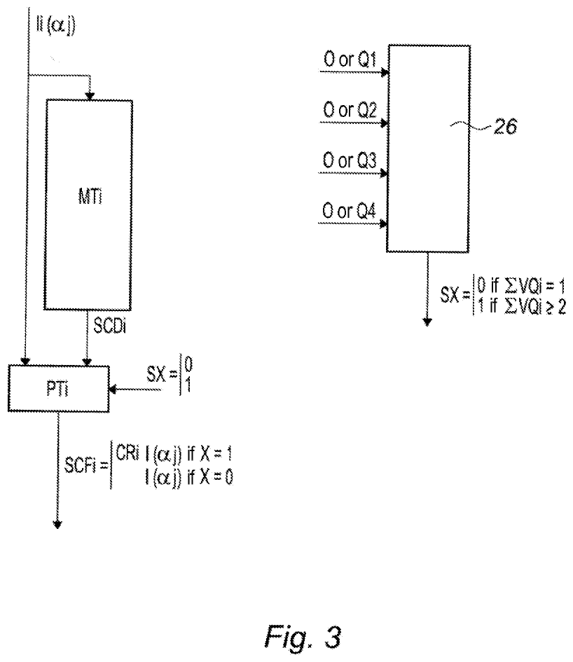

FIG. 1 is an overall diagram of an installation with four branches BRᵢ (i=1 . . . 4), and FIG. 2 shows the extract of the installation, limited to the representation of a single branch BRᵢ which is representative in order to explain more easily the operation of the hydraulic circuit with flow rate sharing in the general case of an installation with n branches BRᵢ (i=1 . . . n). The detail of the control of the operating mode with or without flow rate sharing is shown in detail by means of FIG. 3.

In the case of an excavator, the pieces of equipment Eᵢ are for example a jack 8 which actuates the boom, a jack 9 which actuates the arm supported by the boom, and a jack 10 which actuates the bucket at the end of the arm, as well as a hydraulic motor 11 to control the movement of the turret of the machinery.

The control of the functions Fᵢ of these pieces of equipment Eᵢ takes place by means of associated control units Ji. One piece of equipment Eᵢ can have a plurality of functions Fᵢ, for example the equipment for lifting the arm of the excavator can not only ensure the lifting of the arm with its loaded bucket, but also use the bucket as a flattening unit, and be maneuvered repeatedly up and down by means of the same control unit, which is simply switched to this new function Fᵢ in order to have operating characteristics (speed instead of lifting force) for this other function.

Since the arm of the excavator can receive different pieces of equipment, its functions differ, and need pressures P and flow rates D which are suitable for each function of a single piece of equipment Eᵢ.

According to the embodiment of the disclosure, the distributors Dᵢ which supply the receivers Rᵢ and the pump 1 are controlled by means of control units Jᵢ by electrical signals replacing the intermediate hydraulic and mechanical devices or units of the habitual installations.

The control units Jᵢ which are maneuvered by the operator are control levers and optionally pedals or a slider in order to allow a plurality of control units to execute simultaneously a plurality of functions, and according to variable conditions (pressure and flow rate). The position (αⱼ) in which the operator puts the control unit Jᵢ generates a control signal corresponding to a pressure Pᵢ (αⱼ) and to a flow rate Qᵢ (αⱼ), as well as a signal for control of the distributor Dᵢ, in general an intensity signal Iᵢ (αⱼ) which is dependent on the distributor Dᵢ and on the position (αⱼ) of the control unit, according to a table Tᵢ which will be explained hereinafter.

The control unit Jᵢ can be displaced from a neutral position, or carry out a movement on both sides of a neutral position. The two movement ranges are not necessarily symmetrical; in general they correspond to movements in opposite directions, for example the movement of rising and the movement of descent of the boom of an excavator, which do not have the same characteristics of speed (flow rate) and pressure (load).

The control lever, which is an example of a pivoting control unit Jᵢ, comprises a control sensor for position, which in this case is the angle of pivoting (αⱼ) with which there are associated the pressure Pᵢ (αⱼ) and the flow rate Qᵢ (αⱼ), which are the values required by the receiver Rᵢ, and the intensity Iᵢ (αⱼ) in order to control the distributor Dᵢ and regulate the flow rate supplying the distributor Dᵢ. The relationships between the values (αⱼ, Pᵢ, Qᵢ, Iᵢ) are given in the correspondence table Tᵢ.

The minimal speed No and the pressure POᵢ are values which are recorded in a basic table Toᵢ associated with the branch BRᵢ; this table can be merged with the table Tᵢ of the conversion unit UCᵢ.

The pressures Pᵢ (αⱼ) and flow rates Qᵢ (αⱼ) are characteristics of the equipment Eᵢ and of the receiver Rᵢ which are associated with the control unit Jᵢ. These values depend on the features specific to one piece of equipment or another, or to a series or to an identical type of equipment, and on the functions Fᵢ to be executed.

The values Pᵢ (αⱼ) and Qᵢ (αⱼ) correspond to the operating state of the equipment Eᵢ (8 . . . 11) when the control unit Jᵢ is put into the control position (αⱼ) by the operator.

The unit UCᵢ for conversion of the position (αⱼ) of the control unit Jᵢ provides a signal which is representative of the pressure required Pᵢ (αⱼ) and of the flow rate required Qᵢ (αⱼ) and of the intensity Iᵢ (αⱼ) on the basis of the correspondence tables Tᵢ. These tables are established according to the characteristics of the receivers Rᵢ; they are derived from the experience and study of the movements of the receivers Rᵢ. They are not necessarily symmetrical towards the positive side or the negative side relative to a neutral position. These tables Tᵢ describe for example the flow rate and the pressure during rising and descent of the boom. Like the functions to be controlled, these tables are not necessarily symmetrical towards the positive side or the negative side relative to the neutral position.

Certain control units Jᵢ can also have an amplitude of control which increases starting from the neutral position, and which returns to it without having a negative part.

The pressure Pᵢ (αⱼ) (pressure required) regulates the pressure in the receiver Rᵢ, and the flow rate Qᵢ (αⱼ) (flow rate required) controls the flow rate which supplies the receiver Rᵢ. In the case of electrohydraulic distributors Dᵢ, such as those used by way of preference according to the disclosure, the flow rate required Qᵢ (αⱼ) and the intensity Iᵢ (αⱼ) of the control signal of the distributor Dᵢ are equivalent. The expression of flow rate Qᵢ (αⱼ) is used for certain controls, and its translation into intensity Iᵢ (αⱼ) is used for the control of the distributor Dᵢ, in order to obtain the flow rate which is required or attributed after correction in the case of flow rate sharing.

These two values required Pᵢ (αⱼ) and Qᵢ (αⱼ) are processed in order to form the control signals SPₘₐₓ, SQC applied to the pressure and flow rate regulator 6 of the pump 1; in the present description, this regulator 6 groups the two regulations together schematically.

The control installation 100 comprises:
a processing module MTᵢ (28, 29, etc.) associated with the unit Jᵢ, and generating the control signal SCDᵢ of the distributor Dᵢ;
general means which are common to the branches BRᵢ;
an adder 24 which receives the flow rates required Qᵢ (αⱼ) of the different control units Jᵢ in order to generate the cumulative flow rate signal SQC applied to the regulator 6; and
a selector 25 which receives the pressures required Pᵢ (αⱼ) of the activated equipment Eᵢ in order to extract from it the maximal pressure Pₘₐₓ and form the signal SPₘₐₓ destined for the regulator 6.

The processing module MTᵢ generates the signal SCDᵢ (αⱼ) on the basis of the intensity Iᵢ (aⱼ) representative of the flow rate required Qᵢ multiplied by a corrector coefficient CRᵢ in order to obtain the final control signal SCFᵢ necessary for maneuvering the slider of the distributor Dᵢ towards its side (αⱼ) or (bᵢ) and to supply one of the two chambers of the receiver Rᵢ.

The corrector coefficient CRᵢ depends on the following parameters:

Poᵢ: reference pressure of the actuator; this pressure is measured at the minimal speed of rotation No of the motor for the control scale of the unit Jᵢ;

No: minimal speed;

Pₘₐₓ: maximal pressure possible for the course of the control unit Jᵢ;

N: normal controlled operating speed of the motor.

The minimal speed No and the pressure POᵢ are values which are recorded in a basic table Toᵢ associated with the branch BRᵢ; this table can be merged with the table Tᵢ of the conversion unit UCᵢ.

The coefficient CRᵢ is expressed by the following formula:

$${CR}_{i} = \sqrt{\frac{N}{Pmax * No}} * \sqrt{Poi} \qquad ( 2 )$$

The control signal SCDᵢ is thus expressed as follows:

SCDᵢ=CRᵢ·Iᵢ·(αⱼ))

The coefficient CRᵢ is representative of the receiver Rᵢ in all of the receivers Rᵢ supplied in order to form the control signal SCDᵢ of the distributor Dᵢ, as has just been explained. The intensity Iᵢ, (αⱼ) is that of the current necessary for control of the distributor Dᵢ. This intensity is applied to the distributor Dᵢ in order to control the flow rate Qᵢ (αⱼ) to be supplied to the distributor Dᵢ considered in isolation. It is corrected by the coefficient CRᵢ (αⱼ) in order to share the flow rate Q available supplied by the pump.

If the distributors Dᵢ are the same, the value of the intensity Iᵢ (αⱼ) is the same for all the distributors Dᵢ. However, if the distributors are different, the values Iᵢ (αⱼ) are different, and they are preferably contained in the table Tᵢ associated with each control unit Jᵢ.

FIG. 2, which is completed by FIG. 3, shows the simplified detail of the overall diagram of FIG. 1, limited to a branch BRᵢ of the transmission of the demand introduced by the movement or the position (αⱼ) of the control unit Jᵢ for the distributor Dᵢ which supplies the receiver Rᵢ of the equipment Eᵢ, as well as the common means of the installation implemented in order to apply this demand to the control of the pump 1 and the distributor Dᵢ.

The branch BRᵢ is composed of the conversion unit UCᵢ represented by its table Tᵢ generating the value Qᵢ (αⱼ) of the flow rate required and the pressure required Pᵢ (αⱼ) and the intensity of control (αⱼ) of the distributor Dᵢ.

It comprises the processing module MTᵢ which receives directly the signal Iᵢ (αⱼ) and other signals to be combined in order to obtain as output the control signal SCDᵢ of the distributor Dᵢ of this branch BRᵢ.

The distributor with a slider Dᵢ is controlled in order to regulate (the positive or negative value of) the flow rate passing through the distributor Dᵢ in order to supply one or the other side (chamber) of the receiver Rᵢ in the form of a linear jack or rotary jack (hydraulic motor). The electrohydraulic distributor Dᵢ is controlled by an intensity which takes into account the position (αⱼ) of the control unit Jᵢ corrected by the coefficient CRᵢ if the installation is in flow rate sharing mode.

The different components in material form or the form of program modules are connected to the general means of the installation, which are common to all the branches BRᵢ of the installation.

Thus, the unit UCᵢ is connected to the pressure selector (25) which receives the pressure values Pᵢ (i=1−n) of all the activated branches BRᵢ (i=1−n). The selector 25 retains the maximal pressure value VPₘₐₓ of this set of values received, in order to apply the corresponding signal SPₘₐₓ to the module MTᵢ and to the regulation unit 6 of the pump 1.

The conversion unit UCᵢ is also connected to the processing module MTᵢ and to an adder 24 in order to add the values Qᵢ (αⱼ).

The adder 24 receives the flow rates required Qᵢ (αⱼ) (i=1−n) of all the converters UCᵢ of the activated branches, in order to obtain the sum of the flow rates Qᵢ (αⱼ) and generate a control signal SQC applied to the regulator 6 of the pump 1.

The signals Pᵢ (αⱼ) and Qᵢ (αⱼ) are representative of the operating state required by all the control units Jᵢ (i=1−n). This means that the control units Jᵢ in a neutral position of the branches BRᵢ which are not activated at this moment (t) send a zero signal which does not intervene either in the selection of the pressure Pₘₐₓ or in the sum of the flow rates, such that the regulation unit 6 controls the pump 1 only according to the branches BRᵢ which are active at that instant (t).

The corrector coefficient CRᵢ is obtained from the values Pᵢ (αⱼ) and Qᵢ (αⱼ) of each branch BRᵢ activated, by determining in advance the parameters of each branch BRᵢ taken separately, then using the pressure Pᵢ (αⱼ) and flow rate Qᵢ (αⱼ) values associated with the regulation position (αⱼ) of the control units Jᵢ of the activated branches; the activated branches are those which are connected to the hydraulic circuit of the pump 1 at an instant (t) during the operating phase of the installation 100, in order to control the common means of the installation, the pump 1 and its motor, by means of the control regulator 6 and the means specific to each branch BRᵢ activated, in order to distribute the flow rate Q available at the pressure Pₘₐₓ most appropriate for the demand of the control units Jᵢ. The demand of the branches BRᵢ is the pressure required Pᵢ (αⱼ) and the flow rate Qᵢ (αⱼ). The controlled means of each branch are the distributors Dᵢ.

1) Determination of the Parameters of a Branch BRᵢ:

These parameters depend on the tables Tᵢ giving the flow rate Qᵢ and the pressure Pᵢ of each receiver Rᵢ as well as the intensity Iᵢ (αⱼ) of control of the distributor Dᵢ taken alone, according to the control position (αⱼ) of the control unit Jᵢ associated with each control position (αⱼ) for the control range of the control unit Jᵢ of this receiver Rᵢ.

Tᵢ(αⱼ)↔(αⱼ),Qᵢ(αⱼ)Iᵢ(αⱼ)

The table Tᵢ contains the values Pᵢ (αⱼ), Qᵢ (αⱼ), Iᵢ (αⱼ) obtained by measurement of the real values, carried out during use of the equipment Eᵢ alone in real conditions, by maneuvering the control unit Jᵢ and controlling the pump of the hydraulic circuit and the distributor Dᵢ.

The table Tᵢ is the summary of the measurements carried out according to displacement increments of the control unit Jᵢ associating with each position (αⱼ) a pressure Pᵢ (αⱼ) and a flow rate Qᵢ (αⱼ) (or the intensity Iᵢ (αⱼ) which is representative of the flow rate) specific to the branch BRᵢ and the degree of opening of the distributor Dᵢ according to the control signal (intensity) which is applied to it.
In a following preparatory step, there is determination of the pressure Poᵢ of the receiver Rᵢ for the minimum speed of rotation No of the motor driving the pump 1.
During the ordinary operation of the equipment Eᵢ the pressure Pᵢ and the speed of rotation N of the motor driving the pump 1 are measured. The piece of equipment Eᵢ is the only one activated for these measurements of the variation of pressure Pᵢ according to the speed of rotation N of the motor.

2) Corrector Coefficient CRᵢ:

In order to distribute the flow rate Q supplied by the pump, it is necessary to attribute to each flow rate Qᵢ (αⱼ) required by the equipment Eᵢ activated at that moment (t) a corrector coefficient CRᵢ in order to share the flow rate, and allow all the equipment Eᵢ to operate, even if the operating mode at this moment is more or less reduced as a result of the distribution of the flow rate Q supplied by the pump.

According to the disclosure, the corrector coefficient CRᵢ for each branch BRᵢ (i=1 . . . n) is as follows:

$${CR}_{i} = \sqrt{\frac{Poi * N}{Pmax * No}} \qquad ( 1 )$$

This formula is also written as:

$${CR}_{i} = \sqrt{\frac{N}{Pmax * No}} * \sqrt{Poi} \qquad ( 2 )$$

In this formula:

Poᵢ=pressure in the receiver Rᵢ at the minimum speed No;

No=minimum speed of rotation of the motor;

Pₘₐₓ=maximum pressure of all of the operating pressures required by the equipment Eᵢ (Rᵢ) activated at an instant (t);

N=speed of rotation of the motor of the pump at the instant (t).

The terms Poᵢ and No are fixed values, specific to each piece of equipment Eᵢ recorded in the table Tᵢ associated with the branch BRᵢ.

The pressure Pₘₐₓ is the highest pressure of the pressures Pᵢ required by the equipment Eᵢ activated at the instant t.

N is the speed of rotation of the motor at the instant (t).

Thus, the corrector coefficient CRᵢ makes the following intervene:
terms common to all of the pieces of equipment Eᵢ activated at the instant tin the hydraulic circuit: N, No, Pₘₐₓ;
a term specific to each piece of equipment: Poᵢ;
the coefficient CRᵢ of the branch BRᵢ thus depends solely on the term Poᵢ which is specific to the branch BRᵢ:

CRᵢ=f(Poᵢ)

Since the corrector coefficient CRᵢ is associated with the flow rate required Qᵢ, by analogy with the Torricelli-Bernouilli formula, the following equation is obtained:

Q²=kP or Q=k′√P;

the flow rate being equivalent to a speed of flow, and the real flow rate Qᵢréel supplied to the equipment Eᵢ will depend on the flow rate required:

$$\begin{matrix}{Q}_{i} ( {a}_{j} ) r \hat{e} el = {CR}_{i} * {Q}_{i} ( {a}_{j} ) \\ = f ( {Po}_{i} ) * {Q}_{i} ( {a}_{j} )\end{matrix}$$

The value of Pₘₐₓ is not a constant according to time, but can be modified during an operating phase of the hydraulic installation, since the pieces of equipment Eᵢ activated can change; one piece of equipment Eᵢ stops and/or another one joins the hydraulic circuit; the activation of the equipment Eᵢ can modify the pressure Pₘₐₓ if this piece of equipment Eᵢ has the highest value Pᵢ from amongst the pressures Pᵢ required by the equipment Eᵢ activated at this instant.

The coefficients CRᵢ are specific to all the pieces of equipment Eᵢ including the one corresponding to the pressure Pᵢ=Pₘₐₓ.

3) Determination of the Control Signal SCDᵢ:

The signal SCDᵢ for control of the distributor Dᵢ of the branch BRᵢ in flow rate sharing mode controls the supply of the receiver Rᵢ according to:
parameters of the receiver Rᵢ of the equipment Eᵢ;
the position (αⱼ) of the control unit Jᵢ;
other branches Brⱼ activated at the same time, i.e. the pressure Pⱼ and the flow rate Qⱼ of these branches BRⱼ are activated.

The flow rate Qᵢ and the pressure Pᵢ required by all the receivers Rᵢ activated are values used to distribute the flow rate Q supplied by the pump P at a pressure Pₘₐₓ selected according to the control method which is the subject of the disclosure.

FIG. 1 shows the diagram of a control installation 100 with the references of the general figure (FIG. 2) in which i=1, 2, 3, 4.

4) Determination of the Operating Mode (FIG. 3)

The flow rate sharing operating mode is a downgraded mode which allows all the receivers Rᵢ activated to operate without this operation then making it possible to obtain the maximal performance levels of each piece of equipment Eᵢ.

The flow rate sharing mode does not have as its limit the operating mode for controlling a single receiver Rᵢ activated from amongst all of the receivers concerned.

For this reason, it is necessary to switch the installation between the two modes by means of the switches PTᵢ associated with each branch BRᵢ, but taking into account the interaction which the operation of a single branch BRᵢ presupposes, and which thus does not need flow rate sharing.

The operating mode signal SX is supplied by the computer 26 which receives the flow rates required Qᵢ (αⱼ) of all the control units Jᵢ. These flow rates Qᵢ (αⱼ) are transformed into flow rate values VQᵢ (αⱼ) which are binary logic values:

VQᵢ(αⱼ)=0 if Qᵢ(αⱼ)=0

VQᵢ(αⱼ)=1 if Qᵢ(αⱼ)≠0

The counter 26 counts all the values VQᵢ (αⱼ) received, and supplies the mode signal of SX defined as follows:

SX=|0 if the total ΣQᵢ(αⱼ)=1

|1 if the total ΣQᵢ(αⱼ)≥2

In other words:

SX=0 represents the operation without flow rate sharing

SX=1 represents the operation with flow rate sharing.

The signal SX is applied to all of the switches PTᵢ, irrespective of the operating state required, or the present state of the branches BRᵢ.

The switches PTᵢ switch in the identical mode determined by the signal SX, which they all receive.

If the mode required is that of flow rate sharing, this takes place naturally between the only receivers activated.

If the mode required is the direct mode, without flow rate sharing, all the switches PTᵢ allow the final control signal SCFᵢ=0 to pass.

However, when a single branch BRᵢ is activated, it is the only branch which receives the flow rate at the pressure defined. The corrector coefficient is thus to some extent equal to 1, whereas in flow rate sharing mode the coefficient CRᵢ is always less than 1.

### LIST OF THE MAIN ELEMENTS

100 Control installation
1 Pump
2 Motor
5 Sensor for the speed of rotation of the pump
6 Control regulator of the pump
8 Boom actuator
9 Arm actuator
10 Bucket actuator
11 Turret hydraulic motor
12 Distributor of the boom
13 Distributor of the arm
14 Distributor of the bucket
15 Distributor of the hydraulic motor
16 Control lever of the boom
17 Control lever of the arm
18 Control lever of the bucket
19 Control lever of the turret
20-23 Conversion unit
24 Adder
25 Selection unit
26 Counter
No Minimum speed of rotation
N Speed of rotation
UCᵢ Conversion unit
MTᵢ Processing module
PTᵢ Switch
SCDᵢ (αⱼ) Control signal of the distributor
SCFᵢ Final control signal
SX Operating mode signal
Dᵢ Distributor
Iᵢ, Iᵢ (αⱼ) Basic control intensity of the distributor Dᵢ
Eᵢ Equipment controlled
Fᵢ Function of the equipment
Aⱼ Position of the control unit Jᵢ
Jᵢ Control unit
BRᵢ Branch of the equipment Eᵢ
Tᵢ Table of correspondence between the position (a) of the control unit Jᵢ and the pressure Pᵢ and the flow rate Qᵢ of hydraulic liquid supplying the receiver Rᵢ of the equipment Eᵢ
CRᵢ Flow rate corrector coefficient Qᵢ
Pᵢ (αᵢ),Pᵢ Pressure required by the receiver Rᵢ
Qᵢ (αⱼ),Qᵢ Flow rate required by the receiver Rᵢ
VQI (αⱼ) Flow rate value
Poᵢ Pressure in the equipment Eᵢ for the speed of rotation No
Tᵢ Table of correspondence of the branch BRᵢ
Toᵢ Table of basic values of the branch BRᵢ

What is claimed is:

1. A control system for controlling a hydraulic installation with a plurality of receivers operating in parallel, comprising:
a pump;
a regulator configured to regulate a pressure and a flowrate of the pump;
a plurality of control units, each of the plurality of control units configured to regulate a respective control position of a respective one of the plurality of receivers, and to generate a respective pressure value and a respective flow rate value based upon the respective control position;
a plurality of distributors, each of the plurality of distributors associated with a respective one of the plurality of receivers and configured to supply the respective receiver according to the respective control position;
a plurality of operating mode switches, each of the plurality of operating mode switches associated with a respective one of the plurality of distributors and configured to switch the respective distributor to supply to the respective distributor; and
a flow rate value counter configured to provide an operating mode control signal to the plurality of operating mode switches to switch the plurality of operating mode switches to flow rate sharing mode when at least two of the plurality of receivers are activated, and to a mode without flow rate sharing when only one of the plurality of receivers is activated, wherein
the pump is controlled in flow rate sharing mode by a flow rate regulation signal corresponding to a sum of all of the generated respective flow rate values, and by a pressure signal corresponding to the highest generated respective pressure value, and
each of the plurality of distributors is regulated based upon the respective flow rate value.

2. The control system according to claim 1, wherein each of the plurality of distributors is further regulated based upon on the respective pressure value.

3. The control system according to claim 1, wherein the flow rate value counter is configured to receive the generated respective flow rate values, convert received generated respective flow rates with a flow rate of zero to a binary 0 value, convert received generated respective flow rates with a non-zero flow rate to a binary 1 value, sum the binary values, generate a 0 operating mode control signal when the summed binary values is equal to 1, and generate a 1 operating mode control signal when the summed binary values is greater than 1.

4. The control system according to claim 1, wherein:
the respective control position of each of the plurality of control units is one of a plurality of control positions of each of the plurality of control units;
each one of the plurality of control units is associated with a respective conversion unit containing a respective table of the pressure and flow rate values associated with each of the plurality of control positions of the one of the plurality of control units; and
the pressure and flow rate values in the respective table are obtained by measuring pressure and flow rate for each of the plurality of control positions when the respective operating mode switch is in the mode without flow rate sharing.

5. The control system according to claim 1, wherein in flow rate sharing mode, the respective flow rate value of each of the plurality of control units is combined with a respective corrector coefficient which depends on a pressure required in order to form a respective control signal of the respective one of the plurality of distributors.

6. The control system according to claim 5, wherein each of the plurality of distributors are electrohydraulic distributors controlled by a respective control intensity which depends on the flow rate required by the respective distributor considered alone without flow rate sharing, with the respective control intensity alone controlling a cross-section of a passage between a total closure and opening according to the respective control position, and, in flow rate sharing mode, a respective control signal of the respective distributor is the respective control intensity multiplied by the respective corrector coefficient.

8. The control system according to claim 6, wherein the respective corrector coefficient (CRᵢ) depends on common parameters of the hydraulic circuit according to the formula:
$${CR}_{i} = \sqrt{\frac{N}{Pmax * No}} * \sqrt{Poi} \qquad ( 2 )$$
wherein:
Poᵢ=pressure in the respective receiver at a minimum speed No;
No=minimum speed of rotation of the motor;
Pₘₐₓ=maximum pressure of all of the operating pressures required by each of the plurality of receivers; and
N=speed of rotation of the motor of the pump at the instant (t).

9. A control system for controlling a hydraulic installation with a plurality of receivers operating in parallel, comprising:
a pump which is driven by a motor regulated by a regulator using a received pressure signal and a received cumulative flow rate signal;
a plurality of branches, each of the plurality of branches including
a respective control unit configured to control a respective one of the plurality of receivers,
a respective conversion unit configured to receive a respective control position from the respective control unit and generate a flow rate required and a pressure required,
a respective mode selector configured to switch a respective distributor between a supply with flow rate sharing configuration and a supply without flow rate sharing configuration, and
a respective processing module configured to generate a corrector coefficient of the flow rate required and provide a control signal to the respective distributor (Dᵢ) based upon the generated corrector coefficient for use in the supply with flow rate sharing configuration;
a counter of flow rate values configured to supply an operating mode control signal to the respective mode selectors in order to switch them to flow rate sharing mode when at least two of the plurality of receivers is activated, and to a mode without flow rate sharing when a single receiver of the plurality of receivers is activated;
an adder configured to receive the generated flow rates required and generate a cumulative flow rate signal based upon the receives generated flow rates required;
a maximum pressure selector configured to receive the generated pressures required and retain a maximal pressure required signal based upon the received generated pressures required;
a sensor configured generate a speed signal based upon a sensed speed of the motor; and
a table containing a respective pressure and a respective minimum speed of rotation of the motor of the pump for each of the plurality of receivers taken separately for the motor of the pump rotating at a minimal speed, wherein
the cumulative flow rate signal and the maximum pressure signal are applied to the regulator of the pump,
the maximum pressure signal and generated speed signal are applied to the respective processing modules,
the respective pressure and respective minimum speed of rotation are applied to the respective processing module,
the respective processing modules generate the respective correction signals (Crᵢ) based upon the formula:
$${CR}_{i} = \sqrt{\frac{N}{Pmax * No}} * \sqrt{Poi} \qquad ( 2 )$$
wherein:
Poᵢ=respective pressure in the respective receiver at the respective minimum speed of the motor;
No=respective minimum speed of rotation of the motor;
Pₘₐₓ=maximum pressure signal;
N=sensed speed of rotation of the motor of the pump.

10. The control system according to claim 9, wherein:
in flow rate sharing mode, the respective control signals of the respective distributors is a respective intensity of control of the respective distributor considered alone without flow rate sharing according to the respective control position of the respective control unit multiplied by the respective correction coefficient; and
in the mode without flow rate sharing, the respective control signals are the respective intensity.
